(19) United States
(12) Patent Application Publication
(10) Pub. No.: US 2026/0333491 A1
(43) Pub. Date: Oct. 22, 2026

(54) ENHANCED RADIO LINK FAILURE RECOVERY IN UE-TO-UE RELAY

(71) Applicant: QUALCOMM Incorporated, San Diego, CA (US)

(72) Inventors: Jianhua LIU, Beijing (CN); Karthika PALADUGU, Hyderabad (IN); Hong CHENG, Basking Ridge, NJ (US); Qing LI, Princeton Junction, NJ (US)

(21) Appl. No.: 19/104,632

(22) PCT Filed: Oct. 14, 2022
(86) PCT No.: PCT/CN2022/125327

§ 371 Date: Feb. 18, 2025

(51) Int. Cl. H04W 76/19; H04W 76/15; H04W 88/04

(52) U.S. Cl. CPC H04W 76/19; H04W 76/15; H04W 88/04

(57) ABSTRACT

Methods, systems, and devices for wireless communication are described. A first user equipment (UE) may establish a first end-to-end (E2E) link between the first UE and a second UE, the E2E link including a second link between the first UE and a third UE configured for relaying communications and a third link between the third UE and the second UE. The first UE may determine a link failure on one of the links and perform a recovery process that includes maintaining the first link. The recovery process may include reselecting the third UE for relaying communications and reestablishing the second link between the first UE and the third UE via one or more connection messages based on maintaining the first link. The recovery process may include selecting a fourth UE for relaying communications and release the second link.

### CROSS REFERENCE

This application is a 371 National Stage of PCT Application No. PCT/CN2022/125327, filed on Oct. 14, 2022, entitled “ENHANCED RADIO LINK FAILURE RECOVERY IN UE-TO-UE RELAY”, and assigned to the assignee hereof. The disclosure of the prior Application is considered part of and is incorporated by reference into this Patent Application

### FIELD OF TECHNOLOGY

The following relates to wireless communication, including radio link failure (RLF) recovery in sidelink relay between user equipment (UE).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support radio link failure (RLF) recovery in sidelink relay between user equipment (UE). For example, the described techniques provide for updated link recovery procedures that maintain one or more links of a sidelink communication, which may result in reduced overhead and reduced recovery time associated with communication failures. A first UE may establish a first end-to-end (E2E) link between the first UE and a second UE, the E2E link including a second link between the first UE and a third UE configured for relaying communications and a third link between the third UE and the second UE. The first UE may determine a link failure on one of the links and perform a recovery process that includes maintaining the first link (e.g., maintaining one or more parameters associated with the first link). In some implementations, the recovery process may include reselecting the third UE for relaying communications and reestablishing the second link (e.g., resetting one or more parameters associated with the second link) between the first UE and the third UE via one or more connection messages based on maintaining the first link. In some cases, the recovery process may include selecting a fourth UE for relaying communications and releasing the second link. In some examples, the link failure may be associated with the first E2E link and the first UE may reestablish the first link. Reestablishing the first link may include resetting at least one parameter of the first link.

A method for wireless communication at a first UE is described. The method may include establishing a first, E2E link between the first UE and a second UE, where establishing the first link includes establishing a second link between the first UE and a third UE that is configured to relay communications between the first UE and the second UE, performing a recovery process based on an indication of a link failure, where the recovery process includes maintaining the first link, and communicating with the second UE based on maintaining the first link.

An apparatus for wireless communication at a first UE is described. The apparatus may include a processor, memory coupled with the processor, and instructions stored in the memory. The instructions may be executable by the processor to cause the apparatus to establish a first, E2E link between the first UE and a second UE, where establishing the first link includes establishing a second link between the first UE and a third UE that is configured to relay communications between the first UE and the second UE, perform a recovery process based on an indication of a link failure, where the recovery process includes maintaining the first link, and communicate with the second UE based on maintaining the first link.

Another apparatus for wireless communication at a first UE is described. The apparatus may include means for establishing a first, E2E link between the first UE and a second UE, where establishing the first link includes establishing a second link between the first UE and a third UE that is configured to relay communications between the first UE and the second UE, means for performing a recovery process based on an indication of a link failure, where the recovery process includes maintaining the first link, and means for communicating with the second UE based on maintaining the first link.

A non-transitory computer-readable medium storing code for wireless communication at a first UE is described. The code may include instructions executable by a processor to establish a first, E2E link between the first UE and a second UE, where establishing the first link includes establishing a second link between the first UE and a third UE that is configured to relay communications between the first UE and the second UE, perform a recovery process based on an indication of a link failure, where the recovery process includes maintaining the first link, and communicate with the second UE based on maintaining the first link.

In some examples of the method, apparatuses, and non-transitory computer-readable medium described herein, performing the recovery process may include operations, features, means, or instructions for reselecting the third UE for relaying communications to the second UE based on maintaining the first link and a relay discovery operation.

Some examples of the method, apparatuses, and non-transitory computer-readable medium described herein may further include operations, features, means, or instructions for reestablishing the second link based on reselecting the third UE for relaying communications for the first link, where reestablishing the second link includes utilizing at least one parameter that was associated with the second link prior to performing the recovery process.

In some examples of the method, apparatuses, and non-transitory computer-readable medium described herein, reestablishing the second link may include operations, features, means, or instructions for communicating one or more connection messages with the third UE based on reselecting the third UE, the one or more connection messages including a PC5 sidelink message, a PC5 radio resource control message, a connection setup message, or any combination thereof.

In some examples of the method, apparatuses, and non-transitory computer-readable medium described herein, reestablishing the second link may include operations, features, means, or instructions for transmitting, to the third UE, a message indicating failure recovery based on reselecting the third UE.

In some examples of the method, apparatuses, and non-transitory computer-readable medium described herein, reestablishing the second link may include operations, features, means, or instructions for resetting one or more medium access control parameters to initial values, the at least one parameter including the one or more medium access control parameters.

Some examples of the method, apparatuses, and non-transitory computer-readable medium described herein may further include operations, features, means, or instructions for releasing the second link based on the link failure, where the link failure may be associated with the second link.

In some examples of the method, apparatuses, and non-transitory computer-readable medium described herein, performing the recovery process may include operations, features, means, or instructions for selecting a fourth UE for relaying communications for the first link based on maintaining the first link.

Some examples of the method, apparatuses, and non-transitory computer-readable medium described herein may further include operations, features, means, or instructions for receiving, from the third UE, a message indicating that the link failure may be associated with a third link between the second UE and the third UE.

Some examples of the method, apparatuses, and non-transitory computer-readable medium described herein may further include operations, features, means, or instructions for establishing a third link between the first UE and the fourth UE based on selecting the fourth UE for relaying communications for the first link, where communicating with the second UE may be further based on establishing the third link.

In some examples of the method, apparatuses, and non-transitory computer-readable medium described herein, establishing the third link may include operations, features, means, or instructions for communicating one or more connection messages with the fourth UE based on selecting the fourth UE, the one or more connection messages including a PC5 sidelink message, a PC5 radio resource control message, a link setup message, or any combination thereof.

A method for wireless communication at a first UE is described. The method may include establishing a first, E2E link between the first UE and a second UE, where establishing the first link includes establishing a second link between the first UE and a third UE that is configured to relay communications between the first UE and the second UE, reestablishing the first link based on an indication of a failure associated with the first link, where reestablishing the first link includes resetting at least one parameter associated with flow control over the second link, and communicating with the second UE based on maintaining the first link.

An apparatus for wireless communication at a first UE is described. The apparatus may include a processor, memory coupled with the processor, and instructions stored in the memory. The instructions may be executable by the processor to cause the apparatus to establish a first, E2E link between the first UE and a second UE, where establishing the first link includes establishing a second link between the first UE and a third UE that is configured to relay communications between the first UE and the second UE, reestablish the first link based on an indication of a failure associated with the first link, where reestablishing the first link includes resetting at least one parameter associated with flow control over the second link, and communicate with the second UE based on maintaining the first link.

Another apparatus for wireless communication at a first UE is described. The apparatus may include means for establishing a first, E2E link between the first UE and a second UE, where establishing the first link includes establishing a second link between the first UE and a third UE that is configured to relay communications between the first UE and the second UE, means for reestablishing the first link based on an indication of a failure associated with the first link, where reestablishing the first link includes resetting at least one parameter associated with flow control over the second link, and means for communicating with the second UE based on maintaining the first link.

A non-transitory computer-readable medium storing code for wireless communication at a first UE is described. The code may include instructions executable by a processor to establish a first, E2E link between the first UE and a second UE, where establishing the first link includes establishing a second link between the first UE and a third UE that is configured to relay communications between the first UE and the second UE, reestablish the first link based on an indication of a failure associated with the first link, where reestablishing the first link includes resetting at least one parameter associated with flow control over the second link, and communicate with the second UE based on maintaining the first link.

In some examples of the method, apparatuses, and non-transitory computer-readable medium described herein, reestablishing the first link may include operations, features, means, or instructions for transmitting a first message to reestablish the second link based on selecting the third UE for relaying communications between the first UE and the second UE and transmitting a second message to the second UE via the first link.

In some examples of the method, apparatuses, and non-transitory computer-readable medium described herein, the first message includes an indication to reset at least one parameter associated with flow control over the second link.

In some examples of the method, apparatuses, and non-transitory computer-readable medium described herein, the second message includes an indication to reestablish a protocol layer.

In some examples of the method, apparatuses, and non-transitory computer-readable medium described herein, the second message may be an E2E PC5 radio resource control message and the protocol layer may be a packet data convergence protocol (PDCP) entity.

Some examples of the method, apparatuses, and non-transitory computer-readable medium described herein may further include operations, features, means, or instructions for resetting the at least one parameter associated with flow control over the second link includes resetting one or more medium access control parameters to initial values.

### BRIEF DESCRIPTION OF THE DRAWINGS

FIGS. 1 and 2 illustrate examples of wireless communications systems that support radio link failure (RLF) recovery in sidelink relay between user equipment (UE) in accordance with one or more aspects of the present disclosure.

FIGS. 3 through 5 illustrate examples of process flows that support RLF recovery in sidelink relay between UE in accordance with one or more aspects of the present disclosure.

FIGS. 6 and 7 show block diagrams of devices that support RLF recovery in sidelink relay between UE in accordance with one or more aspects of the present disclosure.

FIG. 8 shows a block diagram of a communications manager that supports RLF recovery in sidelink relay between UE in accordance with one or more aspects of the present disclosure.

FIG. 9 shows a diagram of a system including a device that supports RLF recovery in sidelink relay between UE in accordance with one or more aspects of the present disclosure.

FIGS. 10 through 13 show flowcharts illustrating methods that support RLF recovery in sidelink relay between UE in accordance with one or more aspects of the present disclosure.

### DETAILED DESCRIPTION

Some wireless communications systems may support sidelink communications. The sidelink communications may include a first user equipment (UE) (e.g., a source UE), a second UE (e.g., a destination UE), and a third UE (e.g., a relay UE) configured to relay communications between the first UE and the second UE. The communication link between the first UE and the second UE may be an end-to-end (E2E) link that includes a first hop (e.g., a second link) between the first UE and the third UE and a second hop (e.g., a third link) between the third UE and the second UE. Some sidelink communications may include recovery procedures for communication failures on one or more of the links. For example, one type of communication failure may be a radio link failure (RLF) over the first link, the second link, or the third link. However, the recovery procedures may include releasing all of the links associated with the sidelink communication regardless of where the RLF is detected, resulting in overhead and increased RLF recovery time in reestablishing each link.

The techniques described herein provide for updated link recovery procedures that maintain one or more links of a sidelink communication, which may result in reduced overhead and reduced recovery time associated with communication failures. For example, a first UE may establish a first, E2E link between the first UE and a second UE, the E2E link including a second link between the first UE and a third UE configured for relaying communications and a third link between the third UE and the second UE. The first UE may determine a link failure on one of the links and perform a recovery process that includes maintaining the first link (e.g., maintaining one or more parameters associated with the first link). In some implementations, the recovery process may include reselecting the third UE for relaying communications and reestablishing the second link (e.g., resetting one or more parameters associated with the second link) between the first UE and the third UE via one or more connection messages based on maintaining the first link. In some cases, the recovery process may include selecting a fourth UE for relaying communications and releasing the second link. In some examples, the link failure may be associated with the first E2E link and the first UE may reestablish the first link. Reestablishing the first link may include resetting at least one parameter of the first link.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to RLF recovery in sidelink relay between UE.

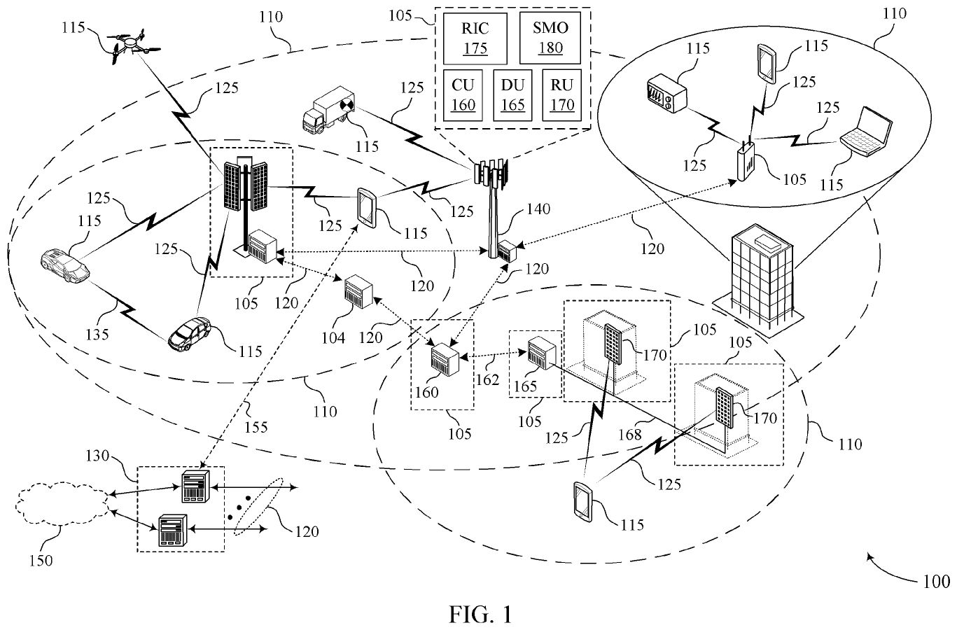

FIG. 1 illustrates an example of a wireless communications system 100 that supports RLF recovery in sidelink relay between UE in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support RLF recovery in sidelink relay between UE as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a first UE 115 may communicate with a second UE 115 via a third UE 115 (e.g., a relay UE 115) as part of a UE-to-UE (U2U) relay operation. The third UE 115 may relay traffic between the first UE 115 and the second UE 115. In some cases, the first UE 115 may be the originator of the relaying traffic (e.g., a source UE 115) and the second UE 115 may be the destination of the relaying traffic (e.g., a destination UE 115), although traffic may also flow from the second UE 115 to the first UE 115 via the third UE 115. To facilitate the relay communication, the first UE 115 may establish a first hop (e.g., a second link, a communication link 135) with the third UE 115 and the third UE 115 may establish a second hop (e.g., a third link) with the second UE 115 in order for the second UE 115 to communicate with the third UE 115. In some examples, the second link and the third link may be an example of single-hop relaying, where a single relay UE 115 relays communications between a source UE 115 and a destination UE 115. In some other examples, the second link and the third link may represent multiple links as part of a multi-hop relay, where multiple relay UEs 115 are connected to each other to support relaying communications between the second UE 115 and the third UE 115 (e.g., a source UE 115 is linked to a first relay UE 115 that is linked to one or more second relay UEs 115). The link between the two remote UEs (e.g., the first UE and the second UE) may constitute an E2E link.

In some examples, the first UE 115 may perform a relay connection procedure (e.g., setup). For example, the first UE 115 may determine to perform a relay procedure associated with L3 relay or L2 relay. The first UE 115 may perform a relay discovery operation to discover potential (e.g., candidate) relay UEs. The first UE 115 may select the third UE 115 and perform a route discovery operation. The first UE 115 may then communicate setup messages with the third UE 115 (e.g., unicast link setup messages) to set up the second link and the third UE 115 may communicate setup messages with the second UE 115 to set up the third link. In some cases, for L3 relay, the first UE 115 may communicate messages to set up the second link that indicate a quality of service (QOS) associated with the L3 relay with the third UE 115 and the third UE 115 may communicate messages with the second UE 115 indicating the QoS. In some cases, for L2 relay, the first UE 115 and the second UE 115, via the third UE 115, may communicate messages associated with an E2E link setup (e.g., E2E unicast link setup) and messages indicating QoS for the E2E link (e.g., E2E unicast link management for PC5 RLC channels). The first UE 115, the second UE 115, and the third UE 115 may be provided with discovery and relay security key material. The UEs 115 may perform sidelink communications (e.g., relay communications).

In some cases, the sidelink communications may include user and/or control data as part of a packet-based network operating according to a layered protocol stack. For example, a control plane and a user plane may include multiple layers as part of the protocol stack. In the user plane (e.g., L2 user plane), the protocol stack may include at least an internet protocol (IP) or other non-IP application or service layer, an SDAP layer, a PDCP layer, a sidelink relay adaptation protocol (SRAP) layer, an RLC layer, a MAC layer, and a PHY layer. In some cases, the IP/non-IP, SDAP, and PDCP layers may be associated with an E2E link and the SRAP, RLC, MAC, and PHY layers may be associated with a relay link. In the control plane (e.g., L2 control plane), the protocol stack may include at least a PC5-S layer, a PDCP layer, an SRAP layer, an RLC layer, a MAC layer, and a PHY layer. In some cases, the PC5-S and PDCP layers may be associated with an E2E link and the SRAP, RLC, MAC, and PHY layers may be associated with a relay link.

In some cases, a UE 115 may determine (e.g., detect, receive an indication of) a failure associated with a link of a sidelink communication (e.g., a sidelink RLF). The failure may be associated with the first link, the second link, the third link, or any combination thereof. In some implementations, the UE 115 may determine the failure based on one or more conditions being satisfied (e.g., existing conditions). For example, the UE 115 may determine an indication (e.g., via an RLC entity) that a retransmission threshold (e.g., a maximum quantity of retransmissions) associated with a physical location (e.g., a destination) has been satisfied. The UE may determine an indication (e.g., via a MAC entity) that a feedback threshold (e.g., a maximum quantity of consecutive hybrid automatic repeat request (HARQ) discontinuous transmission (DTX)) has been satisfied. In some cases, these conditions may be used for E2E RLF detection. In some examples, the UE 115 may fail to receive a response message for a sidelink transmission (e.g., an RRCReconfigurationSidelink message). The UE 115 may perform an integrity check (e.g., an RRC integrity check that verifies the security, integrity, and the like, of data) and determine an integrity failure indication (e.g., from a sidelink PDCP entity) associated with radio bearers (e.g., sidelink signaling radio bearer (SRB) two (SL-SRB2), sidelink SRB three (SL-SRB3), or both). In some cases, these conditions may be used for relay link (e.g., per-hop) RLF detection.

Some wireless communications systems 100 may support recovery procedures for communication failures one or more links of a sidelink relay operation. However, the recovery procedures may include releasing all of the links associated with the sidelink communication regardless of where the communication failure is detected, resulting in overhead and increased failure recovery time in reestablishing each link.

The techniques described herein provide for updated link recovery procedures that maintain one or more links of a sidelink communication, which may result in reduced overhead and reduced recovery time associated with communication failures. For example, a first UE may establish a first E2E link between the first UE and a second UE, the E2E link including a second link between the first UE and a third UE configured for relaying communications and a third link between the third UE and the second UE. The first UE may determine a link failure on one of the links and perform a recovery process that includes maintaining the first link (e.g., maintaining one or more parameters associated with the first link). In some implementations, the recovery process may include reselecting the third UE for relaying communications and reestablishing the second link between the first UE and the third UE via one or more connection messages based on maintaining the first link. In some cases, reestablishing the second link may include restoring the second link for communicating traffic without releasing the second link (e.g., maintaining the second link), thus further communications may occur with at least some of the same communication parameters (e.g., context, security keys, bearers, and the like) prior to reestablishment. In some examples, the first UE may reset the communication parameters to a value prior to reselection of the third UE. In some cases, the recovery process may include selecting a fourth UE for relaying communications and releasing the second link. In some examples, the link failure may be associated with the first E2E link and the first UE may reestablish the first link. Reestablishing the first link may include resetting at least one parameter of the first link.

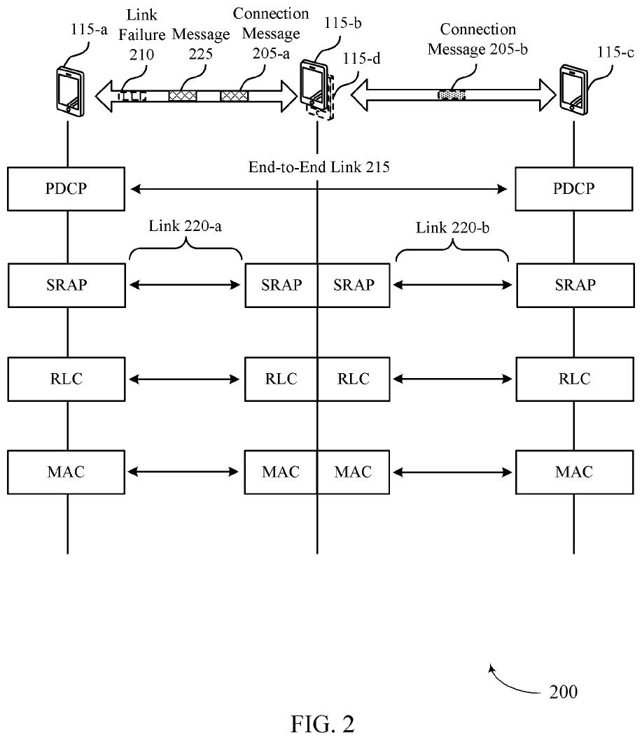

FIG. 2 illustrates an example of a wireless communications system 200 that supports RLF recovery in sidelink relay between UE in accordance with one or more aspects of the present disclosure. In some examples, the wireless communications system 200 may implement aspects of the wireless communications system 100. For example, the wireless communications system 200 may include a UE 115-a, a UE 115-b, a UE 115-c, and optionally a UE 115-d, which may be examples of a UE 115, as described herein with reference to FIG. 1. In some cases, the UE 115-a may represent an example of a source UE 115, the UEs 115-b and 115-d a relay UE 115, and the UE 115-c a destination UE 115, where the source UE 115 and the destination UE 115 are in sidelink communication with the relay UE 115. The source UE 115 may be defined as the originator of relaying traffic and the destination UE 115 may be defined as the destination of relaying traffic. However, it should be understood that the destination UE 115 may also send traffic to the source UE 115 via the relay UE 115. The UE 115-a, the UE 115-b, the UE 115-c, and the UE 115-d, or any combination thereof, may be in wireless communication.

The wireless communications system 200 may include a protocol stack. For example, the protocol stack may include a PDCP layer, an SRAP layer, an RLC layer, and a MAC layer. In some cases, the protocol stack may be an L2 relay protocol stack (e.g., relaying occurs at the L2 layers) in which a first E2E link 215 may be at the PDCP layer, a second link 220-a (e.g., a first relay link) and a third link 220-b (e.g., a second relay link) may be at the SRAP layer, the RLC layer, and the MAC layer. In some cases, a UE 115 may process (e.g., utilize, store, keep) parameters (e.g., identification, headers, footers, buffers, counters, other control data) associated with each layer for communications transmitted as part of a sidelink communication. In some examples, the UE 115-b may process parameters associated with the second link 220-a and the third link 220-b (e.g., per-hop link parameters), the UE 115-a may process parameters associated with the first link 215 and the second link 220-a, and the UE 115-c may process parameters associated with the first link 220-a and the third link 220-b. In some cases, the first link 215, the second link 220-a, and the third link 220-b may include a PC5-S connection, a PC5-RRC connection, or both.

Some wireless communications systems 200 may support recovery procedures for communication failures. The communication failures may be detected by the UE 115-a, the UE 115-b, the UE 115-c, or any combination thereof and may be associated with the second link 220-a, the third link 220-b, or the first link 215. For example, if the failure is associated with the first link 215, the second link 220-a, or the third link 220-b, the UE 115-a may release the link associated with the failure and the other links (e.g., the first link 215, the second link 220-a, and the third link 220-b), regardless of where the failure is detected. Releasing a link may include invalidating (e.g., deleting) a context used for communication via the link, including invalidating parameters associated with the link. Thus, to continue sidelink communication with the UE 115-c, the UE 115-a may discover and select a relay UE (e.g., the UE 115-b, a UE 115-d) and establish new links with the same or a new relay UE and the UE 115-c. However, establishing new links with the relay UE and the UE 115-c may result in avoidable overhead and increased failure recovery time.

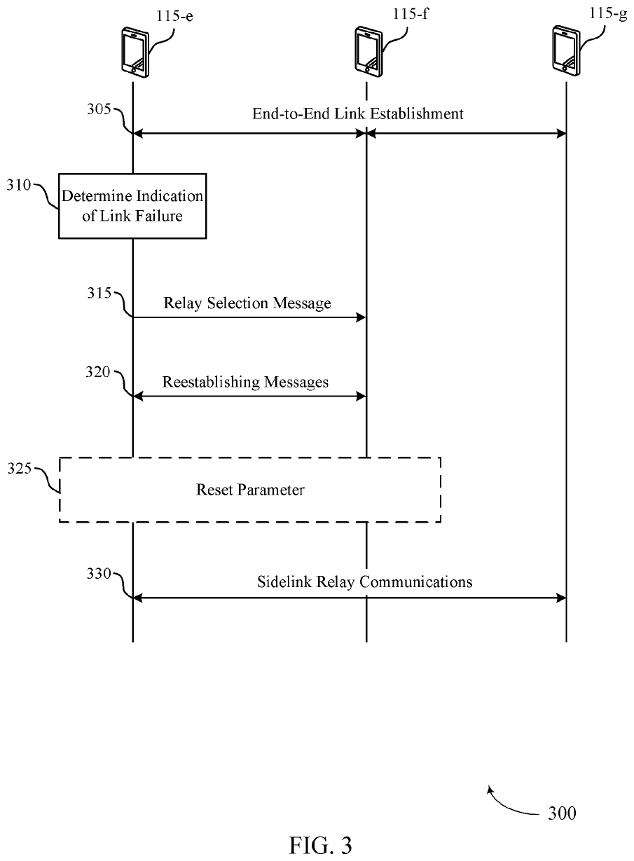

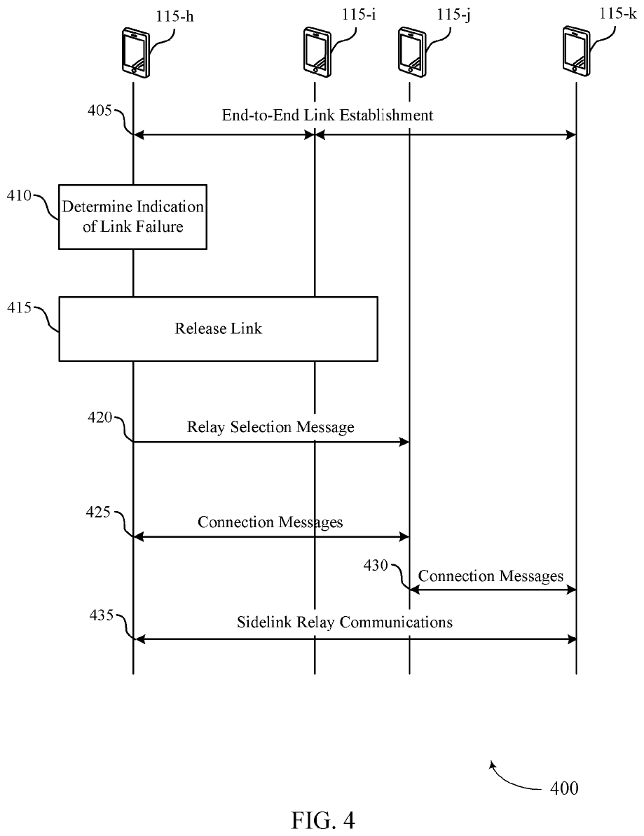

Aspects of the present disclosure may provide improvements to the recovery procedures, which may result in decreased failure recovery time and reduced overhead associated with failure recovery. For example, the UE 115-a may detect a communication failure associated with the second link 220-a. To continue sidelink communications, the UE 115-a may reselect a relay UE. For example, the UE 115-a may perform a discovery operation. In some cases, the discovery operation may include receiving one or more broadcast discovery messages (e.g., multiple discovery messages broadcast from candidate relay UEs) and reselecting the UE 115-b or optionally selecting the UE 115-d (e.g., a new relay UE) based on the discovery messages. The UE 115-a may communicate one or more connection messages 205-a with the selected relay UE 115 (e.g., the UE 115-b or the UE 115-d) to setup a relay communication path (e.g., via one or more new relay links). If the UE 115-a reselects the UE 115-b, the UE 115-b may maintain the third link 220-b and the UE 115-a may maintain the first link 215, as described herein with reference to FIG. 3. If the UE 115-a selects the UE 115-d, the UE 115-d may setup a fourth link 220-b between the UE 115-d and the UE 115-c (or maintain the fourth link 220-b if it is already connected) and the UE 115-a may maintain the first link 215, as described herein with reference to FIG. 4.

In both scenarios (the UE 115-a selects the UE 115-d or if the UE 115-a reselects the UE 115-b) the UE 115-a and the UE 115-c may maintain the first link 215. For example, the UE 115-a and the UE 115-c may maintain one or more parameters associated with the first link 215, thereby reducing the overhead (e.g., latency, additional signaling, power, and the like) associated with communicating the parameter to establish another E2E link 215. The parameters may include a context for the first link 215, such as security keys or bearers used for communication via the first link. In some examples, the UE 115-c may perform a similar recovery procedure (e.g., maintain the first link 215 and optionally the second link 220-a) if the UE 115-c detects a failure on the third link 220-b. In some other examples, the UE 115-c may trigger (e.g., indicate to) the UE 115-a to perform the recovery procedure based on detecting a failure on the third link 220-b.

In some examples, the UE 115-b may detect a failure associated with the third link 220-b. The UE 115-b may attempt to recover communication with the UE 115-c. For example, the UE 115-b may communicate a connection message 205-b (e.g., connection setup messages, failure recovery messages, or both) with the UE 115-c. If the UE 115-b successfully communicates with the UE 115-c, the UE 115-b may reestablish the third link 220-b (e.g., reusing at least some of the context associated with the third link 220-b, resetting one or more parameters of one or more layers associated with the third link 220-b, maintaining the third link 220-b). If recovery attempts fail (or are skipped), the UE 115-b may transmit, to the UE 115-a, a link failure message 210 (e.g., a message indicating a communication failure associated with the third link 220-b) and the UE 115-a may perform the failure recovery procedure.

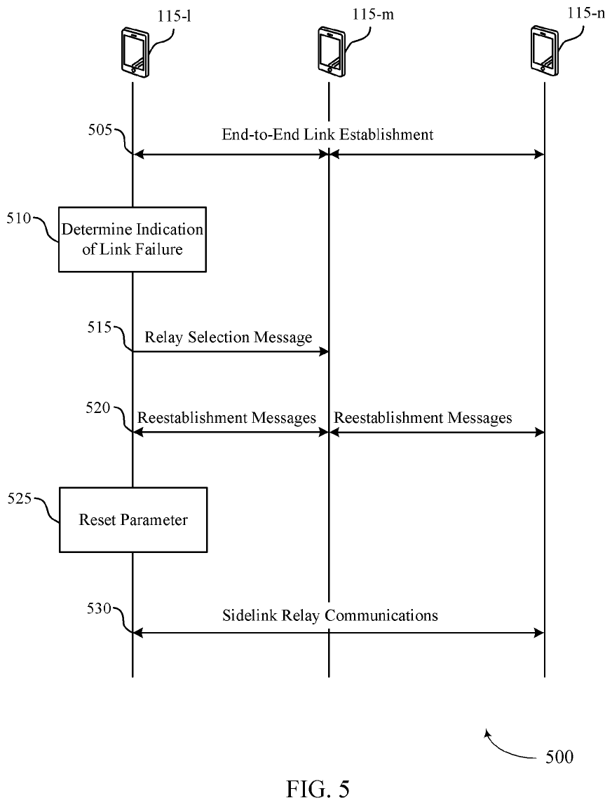

In some examples, the UE 115-a may detect a communication failure associated with the first link 215. The UE 115-a may perform a failure recovery procedure for E2E links in which the UE 115-a may reestablish the E2E link (rather than release the E2E link), as described herein with reference to FIG. 5. Other combinations of detecting and/or indicating failure and performing the recovery procedure (e.g., maintaining one or more links, reestablishing one or more links, and the like), by any of the UEs 115 included in the sidelink communication, may be possible by the aspects of the present disclosure.

In some cases, the UE 115-a may establish two or more communication paths (e.g., relay paths) to the UE 115-c. For example, the UE 115-a may setup a first relay communication path (e.g., a first E2E link 215) with the UE 115-b by communicating one or more connection messages 205-a with the UE 115-b. The UE 115-a may discover the UE 115-d (e.g., a second relay UE 115) and determine to establish a backup per-hop path towards the UE 115-c. Thus, the UE 115-a may setup a second relay communication path (e.g., a second E2E link 215) with the UE 115-d by communicating one or more connection messages 205-a with the UE 115-d (e.g., the UE 115-a may trigger per-hop connection establishment utilizing the UE 115-d). In some cases, the UE 115-a may negotiate (e.g., communicate one or more negotiation messages, request and response messages associated with capability, authorization, and the like) with the UE 115-c to setup the secondary path towards the UE 115-d. In some implementations, one of the relay communication paths (e.g., the first path) may be an active communication path (e.g., actively used for communication) while the other relay communication paths (e.g., the second path) may be a deactivated path (e.g., in a pending state).

In some examples, the UE 115-a may switch from the first relay communication path to the second relay communication path. For example, the UE 115-a may detect a communication failure associated with the second link 220-a (e.g., a link between the UE 115-a and the UE 115-b). To continue sidelink communications, the UE 115-a may determine (e.g., detect) that the second E2E link 215 including the UE 115-d (e.g., the backup path) is available. For example, the UE 115-a may determine that one or more metrics (e.g., parameters, measurements, and the like) associated with the second E2E link 215 satisfy a threshold (e.g., are greater than the threshold, are less than the threshold). In some cases, the threshold may be associated with packet loss, latency, interference, and other channel metrics. The threshold may be preconfigured, configured (e.g., by a remote UE 115, a network entity 105, or both), or both.

The UE 115-a may communicate one or more messages with the UE 115-c to switch to the second E2E link 215 (e.g., the backup path) based on determining that the metrics satisfy the threshold. For example the UE 115-a may communicate one or more messages 225 (e.g., negotiation messages, E2E PC5-S messages, RRC messages) with the UE 115-c (e.g., via the UE 115-b, the UE 115-d) to negotiate switching paths with the UE 115-c. In some implementations, the UE 115-c may accept to switch to the second E2E link 215 and the UE 115-a and the UE 115-c may release the link 220-a and the link 220-b associated with the first E2E link 215 (e.g., the first and second hop links associated with the UE 115-b).

FIG. 3 illustrates an example of a process flow 300 that supports RLF recovery in sidelink relay between UE in accordance with one or more aspects of the present disclosure. In some examples, the process flow 300 may implement or be implemented by aspects of the wireless communications systems 100 and 200 as described with reference to FIGS. 1 and 2. For example, the process flow 300 may be implemented by a UE 115-e, a UE 115-f, and a UE 115-g, which may be respective examples of a source UE 115, a relay UE 115, and a destination UE 115, as described with reference to FIGS. 1 and 2. In the following description of the process flow 300, the operations between the UE 115-e, the UE 115-f, and the UE 115-g may be transmitted in a different order than the example order shown, or the operations performed by the UE 115-e, the UE 115-f, and the UE 115-g may be performed in different orders or at different times. Some operations may also be omitted from the process flow 300, and other operations may be added to the process flow 300.

At 305, the UE 115-e, the UE 115-f, and the UE 115-g may perform a relay connection procedure (e.g., setup). For example, the UE 115-e may perform a relay discovery operation and select the UE 115-f for relaying communications between the UE 115-e and the UE 115-g. The UE 115-e and the UE 115-g may perform route discovery operations and determine a path (e.g., an E2E path, an E2E link) that includes the UE 115-e, the UE 115-f, and the UE 115-g. In some cases, the UE 115-f may represent multiple relay UEs to connect the UE 115-e to the UE 115-g via an E2E path. In some cases, the UE 115-e may select multiple relay UEs to have multiple potential E2E paths between the UE 115-e and the UE 115-g, where one path is activated and the other paths are deactivated (e.g., backup paths). The UE 115-e, the UE 115-f, and the UE 115-g may communicate connection messages to set up the first E2E link. The first E2E link may include a first hop (e.g., a second link) between the UE 115-e and the UE 115-f and a second hop (e.g., a third link) between the UE 115-f and the UE 115-g.

At 310, the UE 115-e may determine a communication failure. For example, the UE 115-e may determine that the failure is associated with the second link between the UE 115-e and the UE 115-f. In some cases, the UE 115-e may determine the failure based on one or more existing conditions (e.g., a retransmission threshold being satisfied, a feedback threshold being satisfied, and the like), as described herein with reference to FIG. 1. The communication failure may be an example of a sidelink RLF.

In some cases, the UE 115-e may maintain (e.g., as part of a recovery process) the first link (e.g., an E2E link 215). For example, the UE 115-e may determine to continue communication with the UE 115-g (e.g., despite the failure associated with the second link). The UE 115-e may maintain one or more parameters associated with the first link (e.g., a counter, a buffer, control data, identifications, and the like). In some cases, the first UE 115-e may maintain the parameters for a duration (e.g., until an elapsed amount of time satisfies a threshold). The UE 115-e may perform a discovery operation for a communication path to continue sidelink communications with the UE 115-g based on maintaining the first link.

At 315, the UE 115-e may transmit, to the UE 115-f, a relay selection message. For example, to continue communication with the UE 115-g, the UE 115-e may receive (e.g., among multiple discovery messages received from multiple potential UEs 115) a discovery message for discovering a communication path to the UE 115-g based on determining the failure associated with the second link. The UE 115-e may determine to reselect the UE 115-f for relaying communications to the UE 115-g. For example, the UE 115-e may determine that the UE 115-f satisfies one or more conditions (e.g., position, signal strength, interference, latency, and the like) for being a relay UE between the UE 115-e and the UE 115-g.

In some cases, the UE 115-e may reestablish the second link based on reselecting the UE 115-f for relaying communications for the first link. For example, the UE 115-e may utilize at least one parameter that was associated with the second link prior to performing (e.g., prior to determining a failure associated with the second link) the recovery process. The UE 115-e may store an identification, buffers, counters, keys, and the like associated with the UE 115-f, the second link, or both, and utilize the parameters to reduce the signaling and control overhead in establishing another second link between the UE 115-e and the UE 115-f.

At 320, the UE 115-e may communicate one or more reestablishment messages with the UE 115-f. In some cases, the reestablishment message may include one or more connection messages. The connection messages may include a PC5 sidelink message, a PC5 RRC message, a connection setup message, or any combination thereof. The UE 115-e may communicate the reestablishment messages as part of the reestablishment process (e.g., utilizing the parameters associated with the second link that were stored prior to performing the discovery process). In some cases, the reestablishing message may include the UE 115-e transmitting, to the UE 115-f, a message indicating failure recovery. For example, the failure recovery indication may indicate per-hop RLF recovery to the UE 115-f.

At 325, the UE 115-e may optionally reestablish a connection between the RLC layer of the UE 115-e and the UE 115-f and reset the MAC layers, as described with reference to FIG. 2. For example, resetting the MAC layers may include resetting (e.g., reverting back to an original value) one or more MAC parameters of the second link. Additionally, or alternatively, the UE 115-e may reset one or more other parameters associated with the second link (e.g., parameters associated with other layers of the protocol stack). At 330, the UE 115-e may communicate with the UE 115-g via the UE 115-f (e.g., via the reestablished second link).

FIG. 4 illustrates an example of a process flow 400 that supports RLF recovery in sidelink relay between UE in accordance with one or more aspects of the present disclosure. In some examples, the process flow 400 may implement or be implemented by aspects of the wireless communications systems 100 and 200 as described with reference to FIGS. 1 and 2. For example, the process flow 400 may be implemented by a UE 115-h, a UE 115-i, a UE 115-j, and a UE 115-k, which may be respective examples of a source UE 115, a relay UE 115, and a destination UE 115, as described with reference to FIGS. 1-3. In the following description of the process flow 400, the operations between the UE 115-h, the UE 115-i, the UE 115-j, and the UE 115-k may be transmitted in a different order than the example order shown, or the operations performed by the UE 115-h, the UE 115-i, the UE 115-j, and the UE 115-k may be performed in different orders or at different times. Some operations may also be omitted from the process flow 400, and other operations may be added to the process flow 400.

At 405, the UE 115-h, the UE 115-i, and the UE 115-k may perform a relay connection procedure (e.g., setup). For example, the UE 115-h may perform a relay discovery operation and select the UE 115-i for relaying communications between the UE 115-h and the UE 115-k. The UE 115-h and the UE 115-k may perform route discovery operations and determine a path (e.g., an E2E path, an E2E link) that includes the UE 115-h, the UE 115-i, and the UE 115-k. In some cases, the UE 115-i may represent multiple relay UEs to connect the UE 115-h to the UE 115-k via an E2E path. In some cases, the UE 115-h may select multiple relay UEs to have multiple potential E2E paths between the UE 115-h and the UE 115-k, where one path is activated and the other paths are deactivated (e.g., backup paths). The UE 115-h, the UE 115-i, and the UE 115-k may communicate connection messages to set up the first E2E link. The first E2E link may include a second link (e.g., a first hop) between the UE 115-h and the UE 115-i and a third link (e.g., a second hop) between the UE 115-i and the UE 115-k.

At 410, the UE 115-h may determine a communication failure. For example, the UE 115-h may determine that the failure is associated with the second link between the UE 115-h and the UE 115-i. In some cases, the UE 115-h may determine the failure based on one or more existing conditions (e.g., a retransmission threshold being satisfied, a feedback threshold being satisfied, and the like), as described herein with reference to FIG. 1. The communication failure may be an example of a sidelink RLF.

At 415, the UE 115-h may release the second link based on determining the failure (e.g., a link failure associated with the second link). For example, the UE 115-h may invalidate (e.g., delete, overwrite, mark as invalid) one or more parameters associated with the second link. In some cases, the UE 115-h may maintain (e.g., as part of a recovery process) the first link (e.g., an E2E link 215). For example, the UE 115-h may determine to continue communication with the UE 115-k (e.g., despite the failure associated with the second link). The UE 115-h may maintain one or more parameters associated with the first link (e.g., counters, buffers, keys, control data, identifications). In some cases, the first UE 115-h may maintain the parameters for a duration (e.g., until an elapsed amount of time satisfies a threshold). The UE 115-h may perform a discovery operation for a communication path to continue sidelink communications with the UE 115-k based on maintaining the first link.

At 420, the UE 115-h may transmit, to a UE 115-j, a relay selection message. For example, to continue communication with the UE 115-k, the UE 115-h may receive (e.g., among multiple discovery messages received from multiple potential UEs 115) a discovery message for discovering a communication path to the UE 115-k based on determining the failure associated with the second link. The UE 115-h may select the UE 115-j for relaying communications to the UE 115-k (e.g., for the first link). For example, the UE 115-h may determine that the UE 115-j satisfies one or more conditions (e.g., position, signal strength, interference, latency, and the like) for being a relay UE between the UE 115-h and the UE 115-k.

At 425, the UE 115-h may communicate one or more connection messages with the UE 115-j. For example, the UE 115-h may establish a fourth link between the UE 115-j and the UE 115-k based on selecting the UE 115-j for relaying communications for the first link. At 430, the UE 115-j may optionally communicate one or more connection messages with the UE 115-k. In some cases, the UE 115-j may already (e.g., prior to the UE 115-h communicating the connection messages) be in communication with the UE 115-k. The connection messages may include a PC5 sidelink message, a PC5 RRC message, a link (e.g., per-hop) setup message, or any combination thereof. The UE 115-k may release connections associated with the third link (e.g., between the UE 115-i and the UE 115-k) based on the fourth link. At 435, the UE 115-h may communicate with the UE 115-k via the UE 115-j (e.g., via the newly established second link).

In some cases, the UE 115-i may detect a failure (e.g., before 410) associated with the third link (e.g., the link between the UE 115-i and the UE 115-k). The UE 115-i (e.g., at 410) may transmit, to the UE 115-h, a message indicating that the link failure is associated with the third link. The UE 115-h may then follow the steps 415 through 435. In some cases, the message may indicate for the UE 115-h to perform a selection process to determine another UE 115 to select for relaying communications.

FIG. 5 illustrates an example of a process flow 500 that supports RLF recovery in sidelink relay between UE in accordance with one or more aspects of the present disclosure. In some examples, the process flow 500 may implement or be implemented by aspects of the wireless communications systems 100 and 200 as described with reference to FIGS. 1 and 2. For example, the process flow 500 may be implemented by a UE 115-l, a UE 115-m, and a UE 115-n, which may be respective examples of a source UE 115, a relay UE 115, and a destination UE 115, as described with reference to FIGS. 1-4. In the following description of the process flow 500, the operations between the UE 115-l, the UE 115-m, and the UE 115-n may be transmitted in a different order than the example order shown, or the operations performed by the UE 115-l, the UE 115-m, and the UE 115-n may be performed in different orders or at different times. Some operations may also be omitted from the process flow 500, and other operations may be added to the process flow 500.

At 505, the UE 115-l, the UE 115-m, and the UE 115-n may perform a relay connection procedure (e.g., setup). For example, the UE 115-l may perform a relay discovery operation and select the UE 115-m for relaying communications between the UE 115-l and the UE 115-n. The UE 115-l and the UE 115-n may perform route discovery operations and determine a path (e.g., an E2E path, an E2E link) that includes the UE 115-l, the UE 115-m, and the UE 115-n. In some cases, the UE 115-m may represent multiple relay UEs to connect the UE 115-l to the UE 115-n via an E2E path. In some cases, the UE 115-l may select multiple relay UEs to have multiple potential E2E paths between the UE 115-l and the UE 115-n, where one path is activated and the other paths are deactivated (e.g., backup paths). The UE 115-l, the UE 115-m, and the UE 115-n may communicate connection messages to setup the first E2E link. The first E2E link may include a second link (e.g., a first hop) between the UE 115-l and the UE 115-m and a third link (e.g., a second hop) between the UE 115-m and the UE 115-n.

At 510, the UE 115-l may determine a communication failure. For example, the UE 115-l may determine that the failure is associated with the first link between the UE 115-l and the UE 115-n. In some cases, the UE 115-l may determine the failure based on one or more existing conditions (e.g., a retransmission threshold being satisfied, a feedback threshold being satisfied, and the like), as described herein with reference to FIG. 1. The communication failure may be an example of a sidelink RLF.

The UE 115-l may perform a reestablishment procedure (e.g., instead of releasing the E2E connection) based on determining the failure. For example, the UE 115-l may perform a discovery operation for a communication path to continue sidelink communications with the UE 115-n based on determining the failure. At 515, the UE 115-l may transmit, to the UE 115-m, a relay selection message. For example, to continue communication with the UE 115-n, the UE 115-l may receive (e.g., among multiple discovery messages received from multiple potential UEs 115) a discovery message for discovering a communication path to the UE 115-n based on determining the failure associated with the second link. The UE 115-l may determine to reselect the UE 115-m for relaying communications to the UE 115-n. For example, the UE 115-l may determine that the UE 115-m satisfies one or more conditions (e.g., position, signal strength, interference, latency, and the like) for being a relay UE between the UE 115-l and the UE 115-n.

In some cases, the UE 115-l may reestablish the first link based on reselecting the UE 115-m for relaying communications for the first link. For example, the UE 115-l may utilize at least one parameter that was associated with the first link prior to performing (e.g., prior to determining a failure associated with the first link) the recovery process. The UE 115-l may store an identification, buffers, keys, counters, and the like associated with the UE 115-m, the UE 115-n, the second link, the first link, or any combination thereof, and utilize the parameters to reduce the signaling and control overhead in reestablishing the first link between the UE 115-l and the UE 115-n.

At 520, the UE 115-l may communicate one or more reestablishment messages with the UE 115-m and the UE 115-n (via the UE 115-m). For example, the UE 115-l may transmit a first message to reestablish the second link and a second message to the UE 115-n to reestablish the first link (e.g., the UE 115-m may relay the second message). The first message may include an indication to reset at least one parameter associated with flow control over the second link. The second message may include an indication to reestablish a protocol layer (e.g., a PDCP entity) for the first link. For example, the first message may include a PC5 RRC message, a connection setup message, or both, and the second message may include an E2E PC5 RRC message, a connection setup message, or both.

At 525, the UE 115-l may reestablish an RLC connection between the UE 115-l and the UE 115-m (e.g., reusing at least one RLC parameter) and reset the MAC layers, as described with reference to FIG. 2. For example, resetting the MAC layers may include resetting (e.g., reverting back to an original value) one or more MAC parameters (e.g., sequence numbers, HARQ processes) of the second link. Additionally, or alternatively, the UE 115-l may reset one or more other parameters associated with the second link (e.g., parameters associated with other layers of the protocol stack). In some cases, the UE 115-n may reestablish a connection between the RLC layer of the UE 115-n and the UE 115-m and reset the MAC layers. At 530, the UE 115-l may communicate with the UE 115-n via the UE 115-m (e.g., via the reestablished second link). In some implementations, the UE 115-n (e.g., a destination UE 115) may perform similar procedures (e.g., the steps 510 through 530) to reestablish the third link between the UE 115-n and the UE 115-m (e.g., if the UE 115-n determines a failure on the third link), while maintaining the first E2E link.

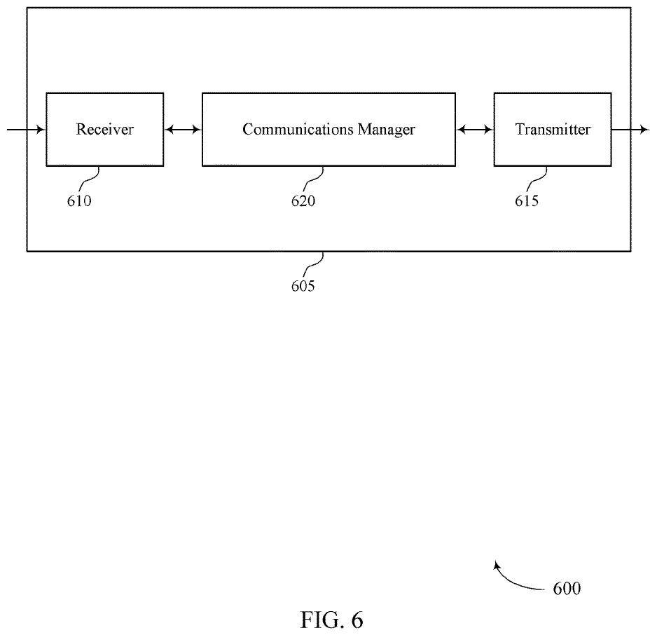

FIG. 6 shows a block diagram 600 of a device 605 that supports RLF recovery in sidelink relay between UE in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to RLF recovery in sidelink relay between UE). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RLF recovery in sidelink relay between UE). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of RLF recovery in sidelink relay between UE as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first UE in accordance with examples as disclosed herein. For example, the communications manager 620 may be configured as or otherwise support a means for establishing a first, E2E link between the first UE and a second UE, where establishing the first link includes establishing a second link between the first UE and a third UE that is configured to relay communications between the first UE and the second UE. The communications manager 620 may be configured as or otherwise support a means for performing a recovery process based on an indication of a link failure, where the recovery process includes maintaining the first link. The communications manager 620 may be configured as or otherwise support a means for communicating with the second UE based on maintaining the first link.

Additionally, or alternatively, the communications manager 620 may support wireless communication at a first UE in accordance with examples as disclosed herein. For example, the communications manager 620 may be configured as or otherwise support a means for establishing a first, E2E link between the first UE and a second UE, where establishing the first link includes establishing a second link between the first UE and a third UE that is configured to relay communications between the first UE and the second UE. The communications manager 620 may be configured as or otherwise support a means for reestablishing the first link based on an indication of a failure associated with the first link, where reestablishing the first link includes resetting at least one parameter associated with flow control over the second link. The communications manager 620 may be configured as or otherwise support a means for communicating with the second UE based on maintaining the first link.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced recovery time from failures (e.g., link failures), reduced processing, reduced power consumption, and more efficient utilization of communication resources.

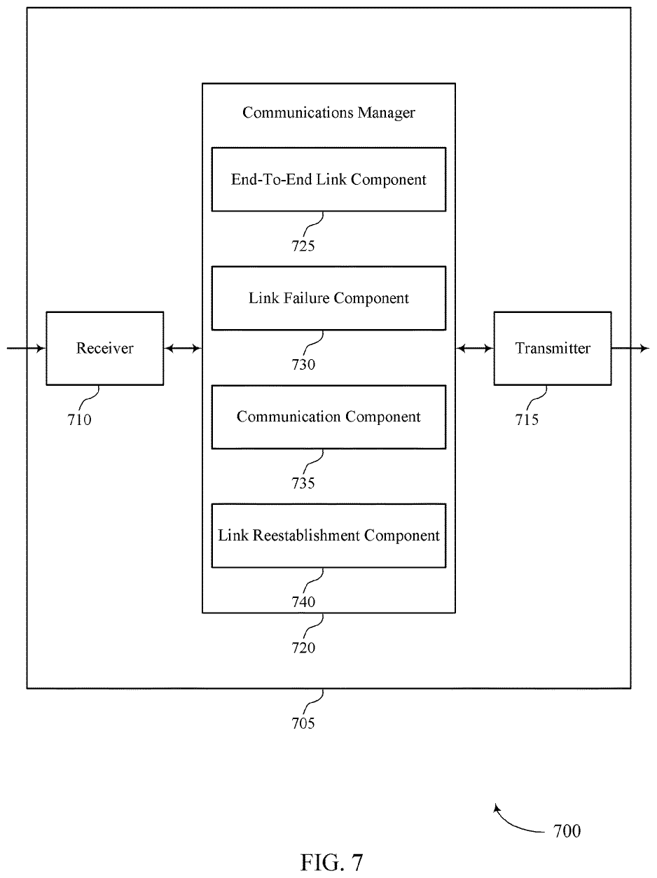

FIG. 7 shows a block diagram 700 of a device 705 that supports RLF recovery in sidelink relay between UE in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to RLF recovery in sidelink relay between UE). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RLF recovery in sidelink relay between UE). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of RLF recovery in sidelink relay between UE as described herein. For example, the communications manager 720 may include an E2E link component 725, a link failure component 730, a communication component 735, a link reestablishment component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. The E2E link component 725 may be configured as or otherwise support a means for establishing a first, E2E link between the first UE and a second UE, where establishing the first link includes establishing a second link between the first UE and a third UE that is configured to relay communications between the first UE and the second UE. The link failure component 730 may be configured as or otherwise support a means for performing a recovery process based on an indication of a link failure, where the recovery process includes maintaining the first link. The communication component 735 may be configured as or otherwise support a means for communicating with the second UE based on maintaining the first link.

Additionally, or alternatively, the communications manager 720 may support wireless communication at a first UE in accordance with examples as disclosed herein. The E2E link component 725 may be configured as or otherwise support a means for establishing a first, E2E link between the first UE and a second UE, where establishing the first link includes establishing a second link between the first UE and a third UE that is configured to relay communications between the first UE and the second UE. The link reestablishment component 740 may be configured as or otherwise support a means for reestablishing the first link based on an indication of a failure associated with the first link, where reestablishing the first link includes resetting at least one parameter associated with flow control over the second link. The communication component 735 may be configured as or otherwise support a means for communicating with the second UE based on maintaining the first link.

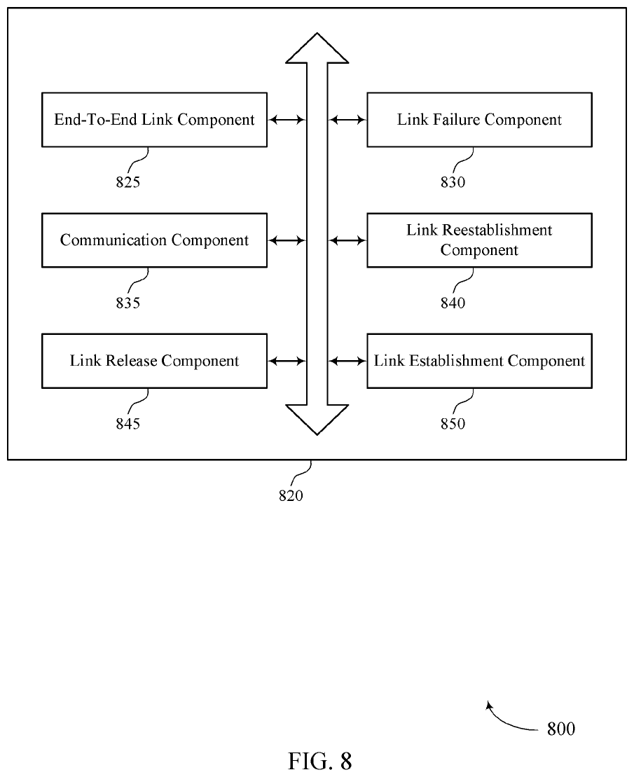

FIG. 8 shows a block diagram 800 of a communications manager 820 that supports RLF recovery in sidelink relay between UE in accordance with one or more aspects of the present disclosure. The communications manager 820 may be an example of aspects of a communications manager 620, a communications manager 720, or both, as described herein. The communications manager 820, or various components thereof, may be an example of means for performing various aspects of RLF recovery in sidelink relay between UE as described herein. For example, the communications manager 820 may include an E2E link component 825, a link failure component 830, a communication component 835, a link reestablishment component 840, a link release component 845, a link establishment component 850, or any combination thereof. Each of these components may communicate, directly or indirectly, with one another (e.g., via one or more buses).

The communications manager 820 may support wireless communication at a first UE in accordance with examples as disclosed herein. The E2E link component 825 may be configured as or otherwise support a means for establishing a first, E2E link between the first UE and a second UE, where establishing the first link includes establishing a second link between the first UE and a third UE that is configured to relay communications between the first UE and the second UE. The link failure component 830 may be configured as or otherwise support a means for performing a recovery process based on an indication of a link failure, where the recovery process includes maintaining the first link. The communication component 835 may be configured as or otherwise support a means for communicating with the second UE based on maintaining the first link.

In some examples, to support performing the recovery process, the link failure component 830 may be configured as or otherwise support a means for reselecting the third UE for relaying communications to the second UE based on maintaining the first link and a relay discovery operation.

In some examples, the link reestablishment component 840 may be configured as or otherwise support a means for reestablishing the second link based on reselecting the third UE for relaying communications for the first link, where reestablishing the second link includes utilizing at least one parameter that was associated with the second link prior to performing the recovery process.

In some examples, to support reestablishing the second link, the link reestablishment component 840 may be configured as or otherwise support a means for communicating one or more connection messages with the third UE based on reselecting the third UE, the one or more connection messages including a PC5 sidelink message, a PC5 RRC message, a connection setup message, or any combination thereof.

In some examples, to support reestablishing the second link, the link reestablishment component 840 may be configured as or otherwise support a means for transmitting, to the third UE, a message indicating failure recovery based on reselecting the third UE.

In some examples, to support reestablishing the second link, the link reestablishment component 840 may be configured as or otherwise support a means for resetting one or more medium access control parameters to initial values, the at least one parameter including the one or more medium access control parameters.

In some examples, to support performing the recovery process, the link failure component 830 may be configured as or otherwise support a means for selecting a fourth UE for relaying communications for the first link based on maintaining the first link.

In some examples, the link release component 845 may be configured as or otherwise support a means for releasing the second link based on determining the link failure, where the link failure is associated with the second link.

In some examples, the link establishment component 850 may be configured as or otherwise support a means for establishing a third link between the first UE and the fourth UE based on selecting the fourth UE for relaying communications for the first link, where communicating with the second UE is further based on establishing the third link.

In some examples, to support establishing the third link, the link establishment component 850 may be configured as or otherwise support a means for communicating one or more connection messages with the fourth UE based on selecting the fourth UE, the one or more connection messages including a PC5 sidelink message, a PC5 RRC message, a link setup message, or any combination thereof.

In some examples, the link failure component 830 may be configured as or otherwise support a means for receiving, from the third UE, a message indicating that the link failure is associated with a third link between the second UE and the third UE.

Additionally, or alternatively, the communications manager 820 may support wireless communication at a first UE in accordance with examples as disclosed herein. In some examples, the E2E link component 825 may be configured as or otherwise support a means for establishing a first, E2E link between the first UE and a second UE, where establishing the first link includes establishing a second link between the first UE and a third UE that is configured to relay communications between the first UE and the second UE. The link reestablishment component 840 may be configured as or otherwise support a means for reestablishing the first link based on an indication of a failure associated with the first link, where reestablishing the first link includes resetting at least one parameter associated with flow control over the second link. In some examples, the communication component 835 may be configured as or otherwise support a means for communicating with the second UE based on maintaining the first link.

In some examples, to support reestablishing the first link, the link reestablishment component 840 may be configured as or otherwise support a means for transmitting a first message to reestablish the second link based on selecting the third UE for relaying communications between the first UE and the second UE. In some examples, to support reestablishing the first link, the link reestablishment component 840 may be configured as or otherwise support a means for transmitting a second message to the second UE via the first link.

In some examples, the first message includes an indication to reset at least one parameter associated with flow control over the second link.

In some examples, the second message includes an indication to reestablish a protocol layer.

In some examples, the second message is an E2E PC5 RRC message and the protocol layer is a PDCP entity.

In some examples, resetting the at least one parameter associated with flow control over the second link includes resetting one or more medium access control parameters to initial values.

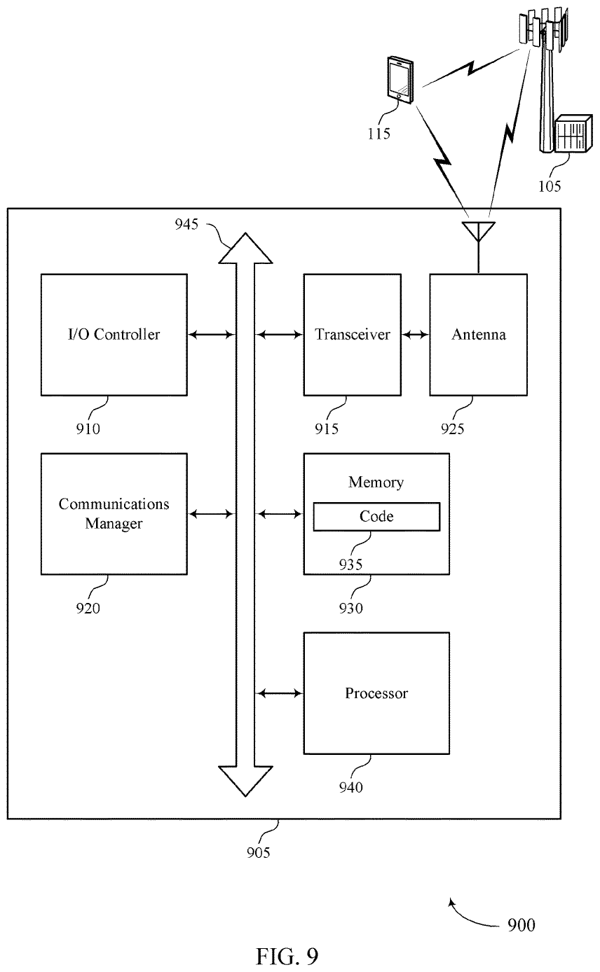

FIG. 9 shows a diagram of a system 900 including a device 905 that supports RLF recovery in sidelink relay between UE in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting RLF recovery in sidelink relay between UE). For example, the device 905 or a component of the device 905 may include a processor 940 and memory 930 coupled with or to the processor 940, the processor 940 and memory 930 configured to perform various functions described herein.

The communications manager 920 may support wireless communication at a first UE in accordance with examples as disclosed herein. For example, the communications manager 920 may be configured as or otherwise support a means for establishing a first, E2E link between the first UE and a second UE, where establishing the first link includes establishing a second link between the first UE and a third UE that is configured to relay communications between the first UE and the second UE. The communications manager 920 may be configured as or otherwise support a means for performing a recovery process based on an indication of a link failure, where the recovery process includes maintaining the first link. The communications manager 920 may be configured as or otherwise support a means for communicating with the second UE based on maintaining the first link.

Additionally, or alternatively, the communications manager 920 may support wireless communication at a first UE in accordance with examples as disclosed herein. For example, the communications manager 920 may be configured as or otherwise support a means for establishing a first, E2E link between the first UE and a second UE, where establishing the first link includes establishing a second link between the first UE and a third UE that is configured to relay communications between the first UE and the second UE. The communications manager 920 may be configured as or otherwise support a means for reestablishing the first link based on an indication of a failure associated with the first link, where reestablishing the first link includes resetting at least one parameter associated with flow control over the second link. The communications manager 920 may be configured as or otherwise support a means for communicating with the second UE based on maintaining the first link.

By including or configuring the communications manager 920 in accordance with examples as described herein, the device 905 may support techniques for reduced recovery time from failures (e.g., link failures), reduced processing, reduced power consumption, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of RLF recovery in sidelink relay between UE as described herein, or the processor 940 and the memory 930 may be otherwise configured to perform or support such operations.

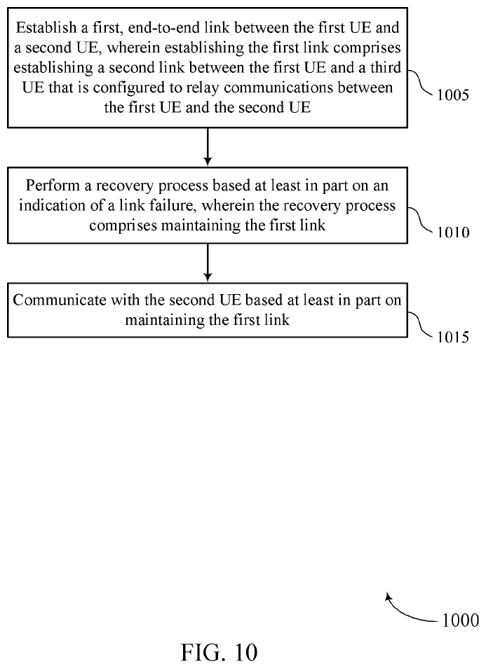

FIG. 10 shows a flowchart illustrating a method 1000 that supports RLF recovery in sidelink relay between UE in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include establishing a first, E2E link between the first UE and a second UE, where establishing the first link includes establishing a second link between the first UE and a third UE that is configured to relay communications between the first UE and the second UE. The operations of 1005 may be performed in accordance with examples as disclosed herein. In some examples, aspects of the operations of 1005 may be performed by an E2E link component 825 as described with reference to FIG. 8.

At 1010, the method may include performing a recovery process based on an indication of a link failure, where the recovery process includes maintaining the first link. The operations of 1010 may be performed in accordance with examples as disclosed herein. In some examples, aspects of the operations of 1010 may be performed by a link failure component 830 as described with reference to FIG. 8.

At 1015, the method may include communicating with the second UE based on maintaining the first link. The operations of 1015 may be performed in accordance with examples as disclosed herein. In some examples, aspects of the operations of 1015 may be performed by a communication component 835 as described with reference to FIG. 8.

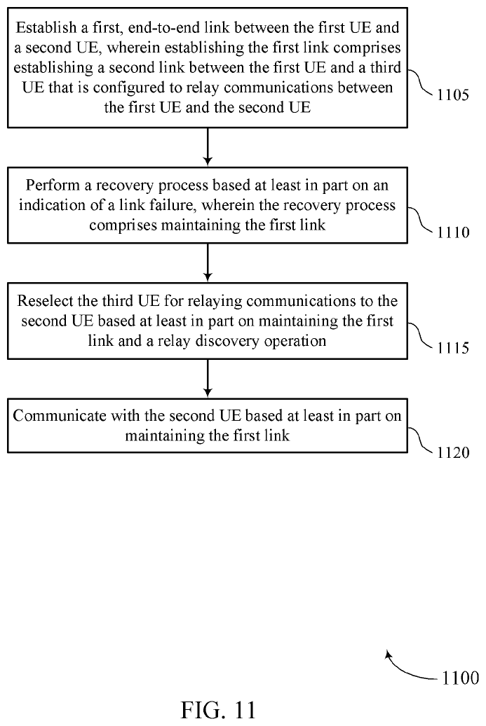

FIG. 11 shows a flowchart illustrating a method 1100 that supports RLF recovery in sidelink relay between UE in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include establishing a first, E2E link between the first UE and a second UE, where establishing the first link includes establishing a second link between the first UE and a third UE that is configured to relay communications between the first UE and the second UE. The operations of 1105 may be performed in accordance with examples as disclosed herein. In some examples, aspects of the operations of 1105 may be performed by an E2E link component 825 as described with reference to FIG. 8.

At 1110, the method may include performing a recovery process based on an indication of a link failure, where the recovery process includes maintaining the first link. The operations of 1110 may be performed in accordance with examples as disclosed herein. In some examples, aspects of the operations of 1110 may be performed by a link failure component 830 as described with reference to FIG. 8.

At 1115, the method may include reselecting the third UE for relaying communications to the second UE based on maintaining the first link and a relay discovery operation. The operations of 1115 may be performed in accordance with examples as disclosed herein. In some examples, aspects of the operations of 1115 may be performed by a link failure component 830 as described with reference to FIG. 8.

At 1120, the method may include communicating with the second UE based on maintaining the first link. The operations of 1120 may be performed in accordance with examples as disclosed herein. In some examples, aspects of the operations of 1120 may be performed by a communication component 835 as described with reference to FIG. 8.

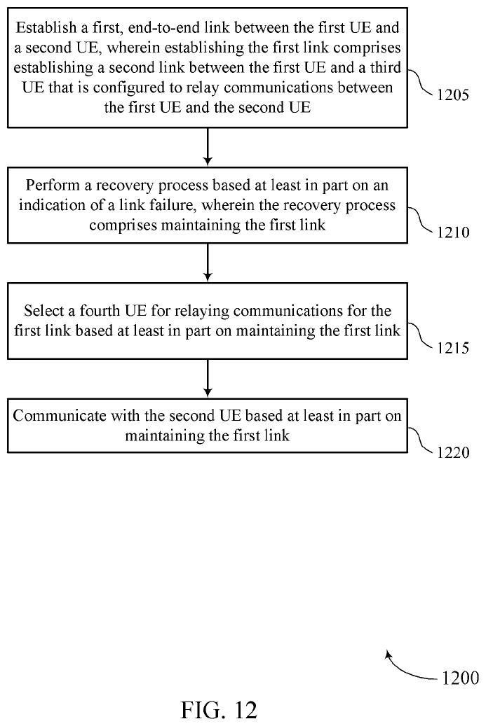

FIG. 12 shows a flowchart illustrating a method 1200 that supports RLF recovery in sidelink relay between UE in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include establishing a first, E2E link between the first UE and a second UE, where establishing the first link includes establishing a second link between the first UE and a third UE that is configured to relay communications between the first UE and the second UE. The operations of 1205 may be performed in accordance with examples as disclosed herein. In some examples, aspects of the operations of 1205 may be performed by an E2E link component 825 as described with reference to FIG. 8.

At 1210, the method may include performing a recovery process based on an indication of a link failure, where the recovery process includes maintaining the first link. The operations of 1210 may be performed in accordance with examples as disclosed herein. In some examples, aspects of the operations of 1210 may be performed by a link failure component 830 as described with reference to FIG. 8.

At 1215, the method may include selecting a fourth UE for relaying communications for the first link based on maintaining the first link. The operations of 1215 may be performed in accordance with examples as disclosed herein. In some examples, aspects of the operations of 1215 may be performed by a link failure component 830 as described with reference to FIG. 8.

At 1220, the method may include communicating with the second UE based on maintaining the first link. The operations of 1220 may be performed in accordance with examples as disclosed herein. In some examples, aspects of the operations of 1220 may be performed by a communication component 835 as described with reference to FIG. 8.

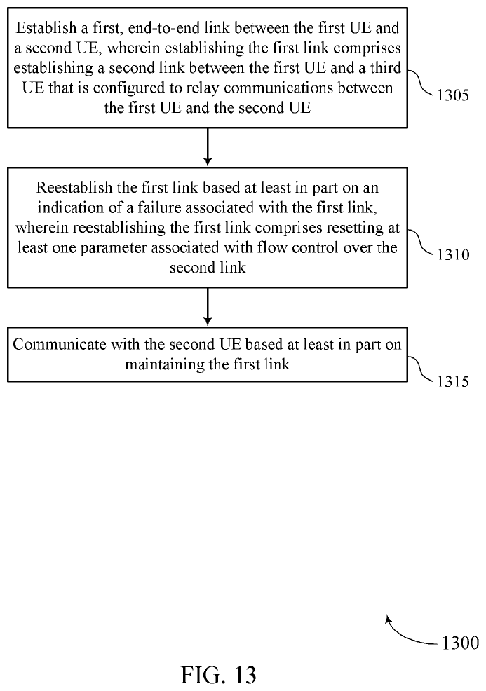

FIG. 13 shows a flowchart illustrating a method 1300 that supports RLF recovery in sidelink relay between UE in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include establishing a first, E2E link between the first UE and a second UE, where establishing the first link includes establishing a second link between the first UE and a third UE that is configured to relay communications between the first UE and the second UE. The operations of 1305 may be performed in accordance with examples as disclosed herein. In some examples, aspects of the operations of 1305 may be performed by an E2E link component 825 as described with reference to FIG. 8.

At 1310, the method may include reestablishing the first link based on an indication of a failure associated with the first link, where reestablishing the first link includes resetting at least one parameter associated with flow control over the second link. The operations of 1310 may be performed in accordance with examples as disclosed herein. In some examples, aspects of the operations of 1310 may be performed by a link reestablishment component 840 as described with reference to FIG. 8.

At 1315, the method may include communicating with the second UE based on maintaining the first link. The operations of 1315 may be performed in accordance with examples as disclosed herein. In some examples, aspects of the operations of 1315 may be performed by a communication component 835 as described with reference to FIG. 8.

The following provides an overview of aspects of the present disclosure:

Aspect 1: A method for wireless communication at a first UE, comprising: establishing a first, E2E link between the first UE and a second UE, wherein establishing the first link comprises establishing a second link between the first UE and a third UE that is configured to relay communications between the first UE and the second UE; performing a recovery process based at least in part on an indication of a link failure, wherein the recovery process comprises maintaining the first link; and communicating with the second UE based at least in part on maintaining the first link.

Aspect 2: The method of aspect 1, wherein performing the recovery process further comprises: reselecting the third UE for relaying communications to the second UE based at least in part on maintaining the first link and a relay discovery operation.

Aspect 3: The method of aspect 2, further comprising: reestablishing the second link based at least in part on reselecting the third UE for relaying communications for the first link, wherein reestablishing the second link comprises utilizing at least one parameter that was associated with the second link prior to performing the recovery process.

Aspect 4: The method of aspect 3, wherein reestablishing the second link comprises: communicating one or more connection messages with the third UE based at least in part on reselecting the third UE, the one or more connection messages comprising a PC5 sidelink message, a PC5 radio resource control message, a connection setup message, or any combination thereof.

Aspect 5: The method of any of aspects 3 through 4, wherein reestablishing the second link comprises: transmitting, to the third UE, a message indicating failure recovery based at least in part on reselecting the third UE.

Aspect 6: The method of any of aspects 3 through 5, wherein reestablishing the second link comprises: resetting one or more medium access control parameters to initial values, the at least one parameter comprising the one or more medium access control parameters.

Aspect 7: The method of any of aspects 1 through 6, further comprising: releasing the second link based at least in part on the link failure, wherein the link failure is associated with the second link.

Aspect 8: The method of aspect 7, wherein performing the recovery process further comprises: selecting a fourth UE for relaying communications for the first link based at least in part on maintaining the first link.

Aspect 9: The method of aspect 8, further comprising: receiving, from the third UE, a message indicating that the link failure is associated with a third link between the second UE and the third UE.

Aspect 10: The method of any of aspects 7 through 9, further comprising: establishing a third link between the first UE and the fourth UE based at least in part on selecting the fourth UE for relaying communications for the first link, wherein communicating with the second UE is further based at least in part on establishing the third link.

Aspect 11: The method of aspect 10, wherein establishing the third link comprises: communicating one or more connection messages with the fourth UE based at least in part on selecting the fourth UE, the one or more connection messages comprising a PC5 sidelink message, a PC5 radio resource control message, a link setup message, or any combination thereof.

Aspect 12: A method for wireless communication at a first UE, comprising: establishing a first, E2E link between the first UE and a second UE, wherein establishing the first link comprises establishing a second link between the first UE and a third UE that is configured to relay communications between the first UE and the second UE; reestablishing the first link based at least in part on an indication of a failure associated with the first link, wherein reestablishing the first link comprises resetting at least one parameter associated with flow control over the second link; and communicating with the second UE based at least in part on maintaining the first link.

Aspect 13: The method of aspect 12, wherein reestablishing the first link comprises: transmitting a first message to reestablish the second link based at least in part on selecting the third UE for relaying communications between the first UE and the second UE; and transmitting a second message to the second UE via the first link.

Aspect 14: The method of aspect 13, wherein the first message comprises an indication to reset at least one parameter associated with flow control over the second link.

Aspect 15: The method of any of aspects 13 through 14, wherein the second message comprises an indication to reestablish a protocol layer.

Aspect 16: The method of aspect 15, wherein the second message is an E2E PC5 radio resource control message and the protocol layer is a PDCP entity.

Aspect 17: The method of any of aspects 12 through 16, wherein resetting the at least one parameter associated with flow control over the second link comprises resetting one or more medium access control parameters to initial values.

Aspect 18: An apparatus for wireless communication at a first UE, comprising a processor; memory coupled with the processor; and instructions stored in the memory and executable by the processor to cause the apparatus to perform a method of any of aspects 1 through 11.

Aspect 19: An apparatus for wireless communication at a first UE, comprising at least one means for performing a method of any of aspects 1 through 11.

Aspect 20: A non-transitory computer-readable medium storing code for wireless communication at a first UE, the code comprising instructions executable by a processor to perform a method of any of aspects 1 through 11.

Aspect 21: An apparatus for wireless communication at a first UE, comprising a processor; memory coupled with the processor; and instructions stored in the memory and executable by the processor to cause the apparatus to perform a method of any of aspects 12 through 17.

Aspect 22: An apparatus for wireless communication at a first UE, comprising at least one means for performing a method of any of aspects 12 through 17.

Aspect 23: A non-transitory computer-readable medium storing code for wireless communication at a first UE, the code comprising instructions executable by a processor to perform a method of any of aspects 12 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first user equipment (UE), comprising:
a processor;
memory coupled with the processor; and
instructions stored in the memory and executable by the processor to cause the apparatus to:
establish a first, end-to-end link between the first UE and a second UE, wherein establishing the first link comprises establishing a second link between the first UE and a third UE that is configured to relay communications between the first UE and the second UE;
perform a recovery process based at least in part on an indication of a link failure, wherein the recovery process comprises maintaining the first link; and
communicate with the second UE based at least in part on maintaining the first link.

2. The apparatus of claim 1, wherein the instructions to perform the recovery process are further executable by the processor to cause the apparatus to:
reselect the third UE for relaying communications to the second UE based at least in part on maintaining the first link and a relay discovery operation.

3. The apparatus of claim 2, wherein the instructions are further executable by the processor to cause the apparatus to:
reestablish the second link based at least in part on reselecting the third UE for relaying communications for the first link, wherein reestablishing the second link comprises utilizing at least one parameter that was associated with the second link prior to performing the recovery process.

4. The apparatus of claim 3, wherein the instructions to reestablish the second link are executable by the processor to cause the apparatus to:
communicate one or more connection messages with the third UE based at least in part on reselecting the third UE, the one or more connection messages comprising a PC5 sidelink message, a PC5 radio resource control message, a connection setup message, or any combination thereof.

5. The apparatus of claim 3, wherein the instructions to reestablish the second link are executable by the processor to cause the apparatus to:
transmit, to the third UE, a message indicating failure recovery based at least in part on reselecting the third UE.

6. The apparatus of claim 3, wherein the instructions to reestablish the second link are executable by the processor to cause the apparatus to:
reset one or more medium access control parameters to initial values, the at least one parameter comprising the one or more medium access control parameters.

7. The apparatus of claim 1, wherein the instructions are further executable by the processor to cause the apparatus to:
release the second link based at least in part on the link failure, wherein the link failure is associated with the second link.

8. The apparatus of claim 7, wherein the instructions to perform the recovery process are further executable by the processor to cause the apparatus to:
select a fourth UE for relaying communications for the first link based at least in part on maintaining the first link.

9. The apparatus of claim 8, wherein the instructions are further executable by the processor to cause the apparatus to:
establish a third link between the first UE and the fourth UE based at least in part on selecting the fourth UE for relaying communications for the first link, wherein communicating with the second UE is further based at least in part on establishing the third link.

10. The apparatus of claim 9, wherein the instructions to establish the third link are executable by the processor to cause the apparatus to:
communicate one or more connection messages with the fourth UE based at least in part on selecting the fourth UE, the one or more connection messages comprising a PC5 sidelink message, a PC5 radio resource control message, a link setup message, or any combination thereof.

11. The apparatus of claim 7, wherein the instructions are further executable by the processor to cause the apparatus to:
receive, from the third UE, a message indicating that the link failure is associated with a third link between the second UE and the third UE.

12. An apparatus for wireless communication at a first user equipment (UE), comprising:
a processor;
memory coupled with the processor; and
instructions stored in the memory and executable by the processor to cause the apparatus to:
establish a first, end-to-end link between the first UE and a second UE, wherein establishing the first link comprises establishing a second link between the first UE and a third UE that is configured to relay communications between the first UE and the second UE;
reestablish the first link based at least in part on an indication of a failure associated with the first link, wherein reestablishing the first link comprises resetting at least one parameter associated with flow control over the second link; and
communicate with the second UE based at least in part on maintaining the first link.

13. The apparatus of claim 12, wherein the instructions to reestablish the first link are executable by the processor to cause the apparatus to:
transmit a first message to reestablish the second link based at least in part on selecting the third UE for relaying communications between the first UE and the second UE; and
transmit a second message to the second UE via the first link.

14. The apparatus of claim 13, wherein the first message comprises an indication to reset at least one parameter associated with flow control over the second link.

15. The apparatus of claim 13, wherein the second message comprises an indication to reestablish a protocol layer.

16. The apparatus of claim 15, wherein the second message is an end-to-end PC5 radio resource control message and the protocol layer is a packet data convergence protocol entity.

17. The apparatus of claim 12, wherein resetting the at least one parameter associated with flow control over the second link comprises resetting one or more medium access control parameters to initial values.

18. A method for wireless communication at a first user equipment (UE), comprising:
establishing a first, end-to-end link between the first UE and a second UE, wherein establishing the first link comprises establishing a second link between the first UE and a third UE that is configured to relay communications between the first UE and the second UE;
performing a recovery process based at least in part on an indication of a link failure, wherein the recovery process comprises maintaining the first link; and
communicating with the second UE based at least in part on maintaining the first link.

19. The method of claim 18, wherein performing the recovery process further comprises:
reselecting the third UE for relaying communications to the second UE based at least in part on maintaining the first link and a relay discovery operation.

20. The method of claim 19, further comprising:
reestablishing the second link based at least in part on reselecting the third UE for relaying communications for the first link, wherein reestablishing the second link comprises utilizing at least one parameter that was associated with the second link prior to performing the recovery process.

21-30. (canceled)
